(19) United States
(12) Patent Application Publication
(10) Pub. No.: US 2004/0037660 A1
(43) Pub. Date: Feb. 26, 2004

(54) Device for the generation of regularly spaced serial recesses in a long workpiece

(76) Inventor: Otmar Fahrion, Kornwestheim (DE)

Correspondence Address: King & Jovanovic, PLC, 170 College Avenue, SUITE 230, HOLLAND, MI, 49423, US

(21) Appl. No.: 10/432,982

(22) PCT Filed: Sep. 19, 2001
(86) PCT No.: PCT/EP01/10801

(30) Foreign Application Priority Data
Nov. 27, 2000 (DE) 10058820.4

(51) Int. Cl. B23G 1/20

(52) U.S. Cl. 408/31; 408/238

(57) ABSTRACT

An apparatus for producing a succession of regularly spaced recesses in an elongate workpiece, in particular in a rail segment for a magnetic levitation system, having a machining head, which comprises at least one tool for the cutting of material, and having a device for producing a relative movement between machining head and workpiece. The machining head is disposed on an undercarriage comprising two sets of guide means, which cooperate with differently inclined boundary surfaces of the workpiece. The undercarriage additionally comprises at least one positioning means, which is capable of cooperating with recesses disposed in the workpiece, in particular being displaceable between an idle position raised off the workpiece and an operating position cooperating in a force-type locking manner with the workpiece.

### BACKGROUND OF THE INVENTION

1. Field of the Invention

The invention relates to a device for producing a succession of regularly spaced recesses in an elongate workpiece in particular in a rail segment for a magnetic levitation system, having a machining head, which comprises at least one tool for the cutting of material, and having a device for producing a relative movement between machining head and workpiece.

2. Background Art

Such machining devices are too elaborate and expensive owing to the long guide surfaces needed for the moving machining unit (or the moving workpiece). For very long workpieces, such as e.g. the roughly 60 m long rail segments for a magnetic levitation system, the cost of the machining device is extremely high. Furthermore, the rail segments, except for those used in straight rail tracks, are bent individually in accordance with the respective geometry of the track layout and are moreover also twisted about their longitudinal axis into curves. In view of the cost of the production plant a restriction to a smaller number of standard rail segments would therefore be necessary, but this would entail concessions regarding the location of the track.

By virtue of the present device a machining device in particular in a rail segment for a magnetic levitation system, having a machining head, which comprises at least one tool for the cutting of material, and having a device for producing a relative movement between machining head and workpiece is to be developed in such a way that, with it, even extremely long workpieces such as the rail segments of the track for a magnetic levitation system may be machined economically.

### SUMMARY OF THE INVENTION

Said object is achieved according to the invention by a device wherein the machining head is disposed on an undercarriage comprising two sets of guide means, which cooperate with differently inclined boundary surfaces of the workpiece, and that the undercarriage additionally comprises at least one positioning means, which is capable of cooperating with recesses disposed in the workpiece, in particular being displaceable between an idle position raised off the workpiece and an operating position cooperating in a force-type locking manner with the workpiece.

In the case of the device according to the invention, the workpiece itself is used as a guide for a machining unit. The latter is moved progressively step by step along the workpiece in order to carry out the work to be effected at each point. The progressive movement of the machining unit is effected in that the machined points already produced in the workpiece are used simultaneously as reference points for the progressive movement of the machining unit.

In the present specification it is assumed that the machining points are recesses which are produced in the workpiece. It goes without saying that it is equally possible to use other machining results, e.g. raised portions on the workpiece, which are produced by welding or otherwise fastening material thereon, or alternatively the results of work such as local polishing or the like, which manifest themselves merely in detectable different optical properties.

The machining unit therefore works its way along in precisely predetermined steps on the workpiece itself.

Said machining is effected preferably from the end so that, when various machined workpieces are placed one after the other, a correct transition in terms of the predetermined pitch is likewise guaranteed. It would however also be possible, in principle, to start machining the workpieces from any desired middle point of the workpiece and then machine the workpiece in both directions towards the two ends.

Advantageous developments of the invention are indicated in the sub-claims.

In one embodiment of the invention the positioning means comprises a contactlessly operating, in particular, an optically operating, detector for a recess as well as a clamping device, which is carried by the undercarriage and cooperates with the workpiece and which in dependence upon the output signal of the recess detector is transferable between a release position and a clamping position. Such an embodiment is advantageous when the work result produced by the machining units leads to only a slight profile change of the workpiece.

In another embodiment of the invention, the positioning means include a positioning part, which is movable without play and at least partially positively into a recess. Such an embodiment is advantageously usable when the machining unit leads to greater contour changes on the workpiece, which are suitable as a starting point for a positioning part operating in a tactile manner.

In one such preferred embodiment, the positioning part has a insertion slant. Advantageously, the self-centering of the positioning part onto the surface contours of the workpiece produced by the machining unit is guaranteed.

In another such preferred embodiment, a servomotor is provided for moving the positioning part between an idle position disengaged from the workpiece and a positioning position of engagement into a recess. Advantageously, the aligning of positioning part and recess is effected by the force of a servomotor.

In a preferred embodiment, the undercarriage has a contactlessly operating recess detector, which preferably responds optically to a recess and by means of the output signal of which the servo motor is movable into its operating position corresponding to the positioning position of the positioning part. Actuation of the latter may be effected a controlled manner by the output signal of a recess detector, which responds to recesses already produced in the workpiece.

In a preferred embodiment, the guide means facing the side walls are adjustable in a transverse direction parallel to the main wall and are preloaded in each case by identically constructed preloading devices in the direction of the adjacent side wall. The effect achieved by this embodiment is that the undercarriage automatically centres itself in a transverse direction to the workpiece longitudinal direction.

In one such embodiment, the preloading devices comprise springs, in particular cup spring stacks. According to such an embodiment, very good positioning with low spring excursions may be achieved even for the usually very heavy machining unit (a machining unit of the type used in practice to machine rail segments of a magnetic levitation system may comprise e.g. six milling machines and six drilling machines).

In one such embodiment, the preloading devices comprise pneumatic cylinders, which are loaded with compressed air via at least one pressure regulator. Such a development allows the self-centring of the undercarriage onto the two lateral surfaces of the rail segment to be effected correctly even in portions where the main surface of the workpiece is inclined relative to the horizontal and weights are additionally involved.

In one specific embodiment, one pressure regulator is provided for each of the pneumatic cylinders associated with the two side walls. Such a device may effect the weight compensation for portions of a rail segment that are inclined in one or the other rolling direction.

In one such preferred embodiment, the pressure regulators are controllable in terms of their control pressure and a signal associated with the inclination of the main wall relative to the horizontal is supplied to their control inputs. As such, compensation of the influence of the weight of the machining unit upon the centring operation may be effected automatically.

Most preferably, the pressure-regulating control signals are derived from an inclination sensor carried by the undercarriage. In such an embodiment, the control signal specifying said compensation may easily be derived from the output signal of an inclination sensor.

Alternatively, the pressure-regulating control signals are derived from a position sensor, which is carried by the vehicle and which supplies a signal corresponding to the instantaneous distance of the machining unit from the end of the workpiece. Accordingly, the compensation control signal may be derived from the output signal of a position sensor carried by the undercarriage, e.g. in that by means of said signal a read-only memory is addressed, in which are filed the inclinations—known from design data of the workpiece—of the main surface portions in dependence upon their distance from the workpiece end.

In a preferred embodiment, the undercarriage carries an operation controller, which controls the operation of the working heads and of the positioning means in dependence upon characteristic data of the workpiece, which are filed in a mass storage device cooperating with the operation controller, or carries a modem part, via which there is a connection to a space-fixed operation controller of said type. The effect achieved by such a development of the invention is that the data needed to control the machining operations are available to the machining unit without the machining unit having to be connected by a long cable to an operation controller.

A machining device, such as one wherein the working heads include at least one milling machine, which is displaceable in a transverse direction to the longitudinal axis of the workpiece, lends itself particularly well to the production in the workpiece of precise transverse grooves having a predetermined profile. Such transverse grooves in a mounting rail of a rail segment for a magnetic levitation system are used to suspend laminated stator cores, into which are inserted the field coils that generate the magnetic field carrying the magnetically levitated vehicle.

In one embodiment, the milling machine or the milling cutter is additionally displaceable in axial direction. The development of such an embodiment of the invention makes it possible by moving the milling cutter transversely also to vary the depth of the groove produced by it.

In another embodiment, the milling machine is additionally displaceable in longitudinal direction of the workpiece. With a machining device of such an embodiment, it is also possible to produce recesses which, viewed in longitudinal direction of the workpiece, have a larger dimension than the milling cutter used.

The development of the invention wherein the working heads include at least one drilling machine makes it possible to produce in the workpiece a regular pattern of bores that are used e.g. to mount fastening means. Such fastening means are used in rail segments for a magnetic levitation system to fix the laminated cores, which are inserted into the recesses, in their position.

In a preferred embodiment, the undercarriage carries a plurality of milling machines and/or drilling machines disposed successively at identical intervals in longitudinal direction of the workpiece. Such a preferred embodiment is advantageous in view of an overall short machining time of the workpiece.

In yet another preferred embodiment, the milling machines and the drilling machines are combined into groups. With such an embodiment, the various milling machines and drilling machines can be used for different purposes. For instance, the milling machines arranged successively in workpiece longitudinal direction may first be provided with identical cutters and then the machining unit after each work cycle may be moved on by the length of the entire group, or the milling machines may be equipped with different cutters, e.g. for rough milling, intermediate milling and fine milling, and the machining unit is then moved on in each case only by the distance of a single recess.

In yet another preferred embodiment, the groups of milling machines and the group of drilling machines are carried by independent undercarriages, which are connected to one another by joints, preferably by cardan joints or ball-and-socket joints. Such an embodiment enables the use of the machining device also on workpieces that are curved and/or twisted to a greater extent.

Given the use of not just a single positioning means but, for the sake of safety and accuracy, a plurality of positioning means arranged successively in workpiece longitudinal direction, said positioning means may equally be provided on a separate undercarriage in order to enable the machining of workpieces that are curved and/or twisted to a greater extent.

In one such embodiment, the hinge points of the joints lie at the height of the neutral axis of the portions of the workpiece which are to be machined. Advantageously, machining inaccuracies stemming from the bending and/or twisting are avoided by the flexible joint between the individual undercarriages.

In another preferred embodiment, a plurality of independently movable undercarriages are provided, which each carry at least one working head. Preferably, such an embodiment is advantageous in view of particularly fast machining of a workpiece. In principle it would be possible, in a factory where long workpieces such as rail segments for the track layout of a magnetic levitation system are manufactured, to set up a plurality of independent production lines. These, however, take up a lot of room and are costly. With the development of the invention according to claim 24 faster machining of a workpiece combined with an identical spatial requirement for the machining device is achieved. What is more, the costs for the elaborate support of the workpiece are saved.

In a preferred embodiment, parking parts, which are situated near the ends of the workpiece and have boundary surfaces, which at least in the surface regions cooperating with the guide means are a uniform smooth continuation of the boundary surfaces of the workpiece. Such an embodiment allows the workpieces to be machined right up to their ends. It is moreover possible to park the heavy machining unit in the immediate vicinity of the actual work area and without the aid of lifting means while a finished workpiece is exchanged for a fresh one.

In such a preferred embodiment, the parking parts have identical cross sections and an identical construction to portions of the workpiece. With such a preferred embodiment, the machining unit runs under exactly identical conditions over the end of the workpiece. This is advantageous for the accuracy of machining of the end recesses.

In a preferred embodiment, the parking parts are carried by base units, which have fastening parts that are adjustable in height and/or inclination. Advantageously, such an embodiment, allows the parking parts to be connected evenly and smoothly to the ends of the workpiece.

In one such preferred embodiment, the base units for the parking parts are of a substantially identical construction to the base units used to support the workpiece. Such an embodiment is advantageous in terms of the low cost of the base units for the parking parts, because these do not have to be specially designed and may be taken substantially without modification from the stock of base units needed in any case to support the workpiece.

### BRIEF DESCRIPTION OF THE DRAWINGS

There now follows a detailed description of embodiments of the invention with reference to the drawings. Said drawings show:

FIG. 1: a side view of a device for machining the stator mounting rail of a rail segment for a magnetic levitation system;

FIG. 2: a side view of a portion of the stator mounting rail of the rail segment according to FIG. 1 with several stator segments suspended therein;

FIG. 3: a detail from a portion of the stator mounting rail according to FIG. 2, wherein a positioning unit is additionally shown;

FIG. 4: a transverse section through the machining device shown in FIG. 1 along the cutting line IV-IV of FIG. 1;

FIG. 5: a side view of a support for a workpiece end as well as a support for a parking part, which continues the rail segment;

FIG. 6: a side view of a support for the middle of the rail segment, such as is used in the machining device according to FIG. 1;

FIG. 7: a side view of a further base unit, such as is used at intermediate points of the rail segment for support and vibration-damping purposes;

FIG. 8: a view of the base unit according to FIG. 7 in longitudinal direction of the workpiece; and

FIG. 9: a diagrammatic side view of a modified machining unit for use in the machining device according to FIG. 1.

### DETAILED DESCRIPTION OF THE DRAWINGS

While this invention is susceptible of embodiment in many different forms, there is shown in the drawings and described herein in detail a specific embodiment with the understanding that the present disclosure is to be considered as an exemplification of the principles of the invention and is not intended to limit the invention to the embodiment illustrated.

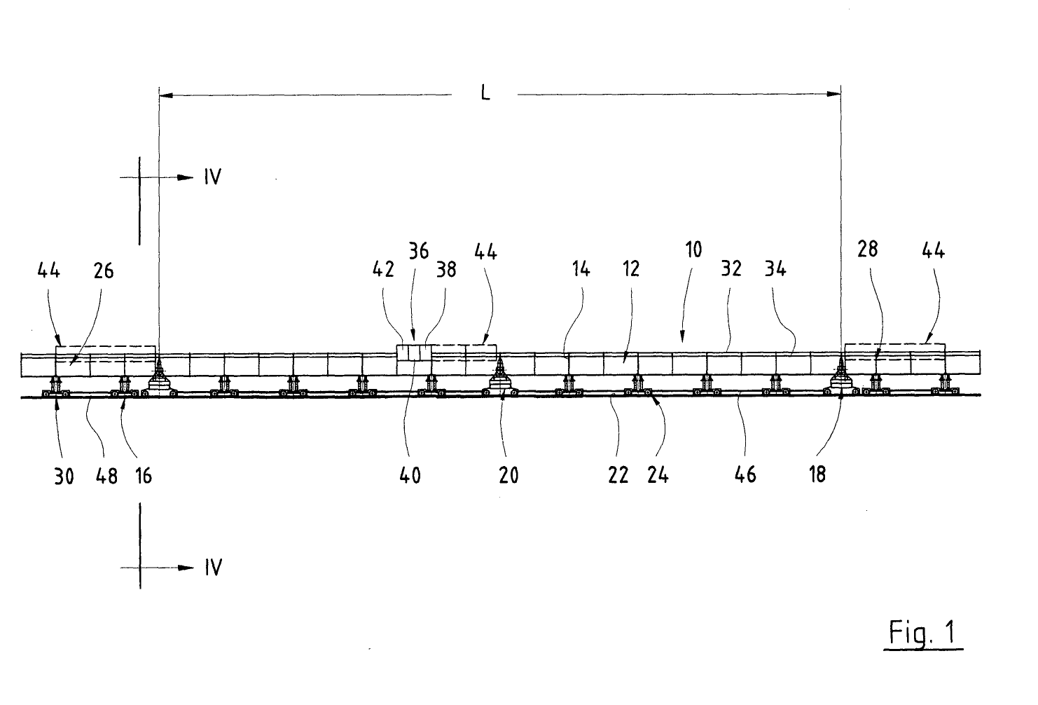

In FIG. 1 a rail segment, which is used to realize the travel way of a magnetic levitation system, is denoted as a whole by 10. The total length of the rail segment, which is denoted by L in FIG. 1, is typically 60 m.

The rail segment 10 comprises a closed box section 12, onto which reinforcing plates 14 are welded at intervals of approximately 3 m.

The rail segment 10 is supported via two end base units 16, 18 and a middle base unit 20 on a factory hall floor denoted by 22. Further intermediate base units 24 support the rail segment 10 at, in each case, four intermediate points lying between adjacent base units.

The base units 16-20 correspond to support points for the rail segment, such as are also to be provided in the finished track layout, the intermediate base units 24 are used as additional support for the rail segment 10 for a machining operation and to damp vibrations arising during the machining operation.

At each end of the rail segment 10 a parking segment 26 and/or 28 is provided, which is carried in each case by two base units 30, which correspond in their construction substantially to the intermediate base units 24 but enable fixing of the associated parking segment 26, 28.

As is evident from FIG. 1, the base units 30 of the parking segments 26, 28 are offset inwards in each case by a grid dimension from the segment ends, thereby achieving symmetrically freely projecting end portions of the parking segments 26, 28 that are connectable evenly and smoothly to the ends of the rail segment 10. The parking segments 26, 28 are of exactly the same cross section and the same construction as a rail segment 10, being however only shorter. By constructing the parking segments 26, 28 symmetrically relative to a transverse centre plane it is guaranteed that the base units 30 associated with them do not have to absorb tilting moments in the unloaded state of the parking segment.

The rail segment 10, the structure of which is described in greater detail below, has a top horizontal main wall 32 and vertical side walls 34 extending down from its side edges.

A machining unit denoted as a whole by 36 is shown running along the rail segment 10 and is composed of three sub-units, namely a milling unit 38, a positioning unit 40 and a drilling unit 42. The structure of the machining unit 36 is described in greater detail later.

Where required, a plurality of machining units 36 may be flexibly marshalled into a train and/or larger machining unit, as indicated by dashes at 44. The length of the parking segments 26, 28 is such that there is room on them for the entire train 44, so that on completion of the machining of a rail segment 10 a train 44 may be parked, substantially without a change of height and without the aid of lifting tools or the like, in order to remove the finished rail segment 10 and insert a fresh rail segment for machining. The parking segments 26, 28 moreover allow the rail segment 10 to be machined right up to its end faces, as will be described in greater detail.

As is evident from FIG. 1, the base units 16, 18, 24 are connected preferably in a flexible manner by coupling rods 46 situated between them.

The base units 30 are connected to one another, not however to the adjacent base unit 16 and/or 18, by a coupling rod 48.

As is apparent from FIG. 4, the box section 12 is welded together from a plurality of steel plates. Emanating from the bottom portions of the side walls 34 are transverse plates 50. The plates 50 are welded via vertical intermediate plates 54 to the lateral regions of the main wall 32.

Welded to the plates 50 and the intermediate plates 54 are stator mounting rails 56. The latter comprise a continuous rolled steel section.

The inner ends of the mounting rails 56 are connected by bent metal sheets 52 in a sealed manner to the side walls of the box section 12.

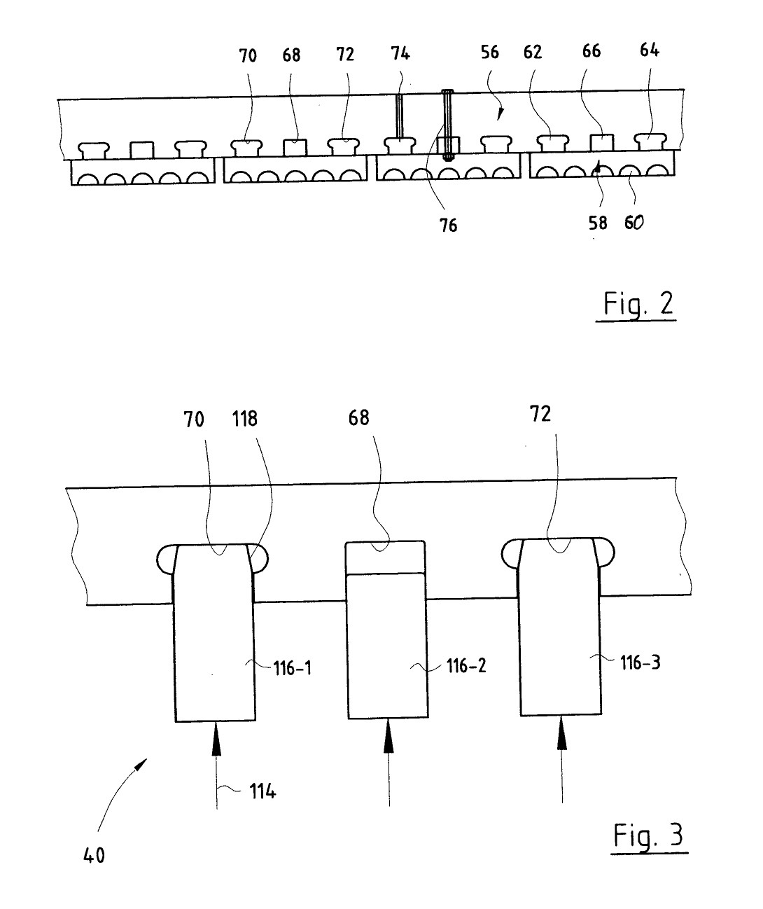

In order to suspend laminated stator cores in the stator mounting rails 56, the mounting rails 56 are provided with grooves of the type illustrated in detail in FIG. 2.

This shows laminated stator cores 58, which comprise a plurality of stator segments stacked one behind the other in a direction at right angles to the drawing plane of FIG. 2. Provided in the undersides of the stator cores 58 are transverse receiving grooves 60, which subsequently receive the conductors of the field winding of the linear magnet carrying the magnetically levitated vehicle.

At the top, each stator core has two end mounting portions 62, 64, which have a substantially T-shaped cross section. A middle positioning portion 66 has a rectangular cross section.

In a corresponding manner, for each stator core one positioning groove 68 and two mounting grooves 70, 72 disposed on either side thereof are provided in the underside of the mounting rail 56. The positioning groove 68 is an exact fit for the positioning portion 66 of the stator cores 58 in order to position the latter exactly in longitudinal direction of the mounting rail 56. The mounting grooves 70, 72 correspond in cross section to the cross section of the mounting portions 62, 64, but with less sliding play, so that the stator cores 58 may be inserted into the mounting rail 56 in a lateral direction, i.e. a direction extending at right angles to the drawing plane in FIG. 2.

In order to be able to produce the various grooves 68, 70, 72 in the mounting rails 56, and moreover to be able to produce in the mounting rail through-bores 74, at which the stator cores 58 after being slipped on may be secured by means of screws 76, the travelling machining unit 36 is moved step by step along the rail segment 10. As will be described in greater detail below, the machining unit 36 is designed in such a way that during each machining step it produces one set of grooves 68, 70, 72 and one set of through-bores 74.

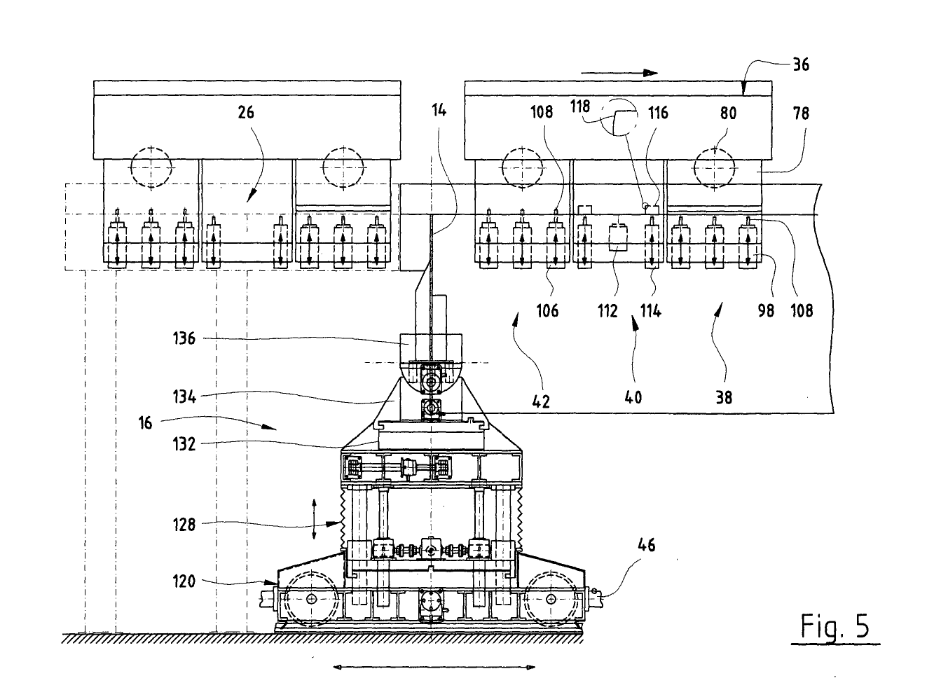

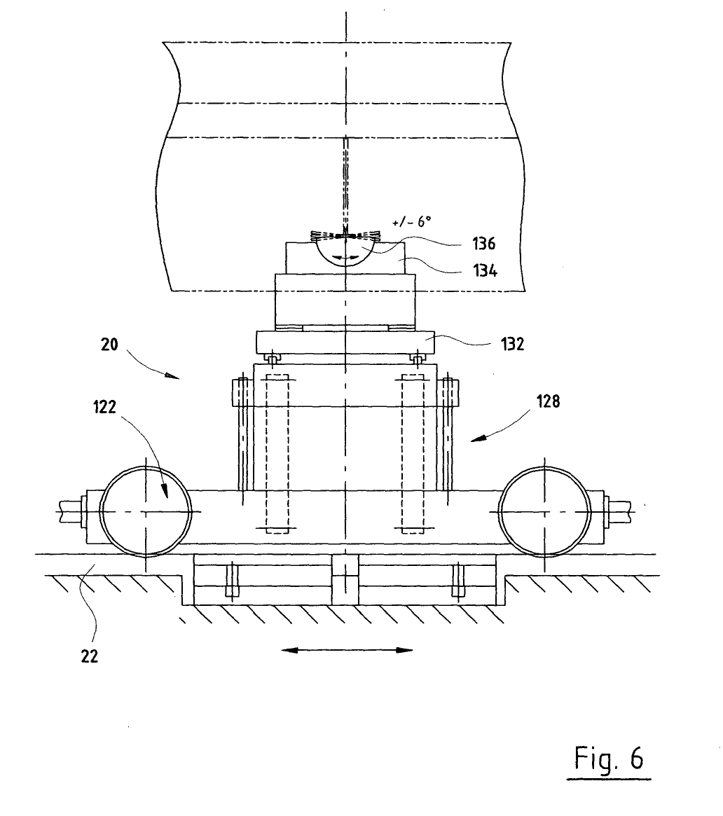

As is evident from FIGS. 4 and 5, the travelling machining unit 36 has a U-shaped frame 78 lapping over the top portion of the rail segment 10. In the base portion of the frame 78 four support rollers 80 are rotatable about axes extending parallel to the main wall 32 and transversely relative to the longitudinal direction of the rail segment 10 (the latter is at right angles to the drawing plane of FIG. 4).

Cooperating with the side walls 34 are four guide rollers 82, which rotate about axes lying perpendicular to the plane of the main wall 32.

The bearing blocks (not illustrated in detail) for the return rollers 82 are preloaded in the direction of the adjacent side wall 34 by diagrammatically indicated cup spring stacks 84. Said bearing blocks are additionally subject to an adjustable force, which is generated by pneumatic cylinders 86.

Whilst the cup spring stacks 84 are all of an identical construction, it is possible by varying the pressure load of the pneumatic cylinders 86 to compensate the weight component of the machining unit 36 that is obtained when the main wall 32 is inclined relative to the horizontal, as shown in FIG. 4. For said purpose, the working chambers of the pneumatic cylinders 86 acting as pneumatic springs are connectable in each case by a controllable pressure regulator 88 to a compressed-air line 90.

The pressure regulator 88 has an adjustable control pressure, which may be realized e.g. by loading its regulating body with a variable additional force, which is provided by a magnet 92 supplied with variable current, as indicated by a variable resistor 94. The resistor 94 may be a programmable resistor, which is electrically controllable, or a slide resistor or the like, which may be adjusted by means of a servomotor. In any case, by applying an electrical signal the pressure of the air supplied to the pneumatic cylinders 86 may be adjusted.

The control signals for the controllable pressure regulator 88 may either be derived from production data of the rail segment 10, which indicate for each point of the rail segment the inclination of the main wall 32 (e.g. relative to a segment end). Alternatively, the inclination of the machining unit 36 may be measured by an inclination sensor 96, which is disposed on the machining unit 36 and provides a corresponding output signal.

The milling unit 32 comprises on either side of the rail segment 10 three milling heads 98, which are disposed at identical intervals in longitudinal direction and are displaceable in transverse direction by means of a servo drive (not shown in detail), in the manner indicated by an arrow 100. The milling heads 98 are moreover displaceable in axial direction, in the manner indicated by an arrow 102.

If required, the milling heads 98 are additionally displaceable in a direction at right angles to the drawing plane of FIG. 4 (workpiece longitudinal direction) if no work involving profiling cutters is to be carried out.

Cutters 104 clamped into the milling heads 98 have a silhouette corresponding to the silhouette of the type of groove (mounting groove or positioning groove) required in each case.

The drilling unit 42 has on either side of the rail segment a multiple drilling head 106 with six spindles, each of which carries a drill bit 108, by means of which a through-bore 74 may be produced. The structure of the multiple drilling heads 106 is selected in accordance with the drill-hole pitch pattern of the stator mounting rail 56. The multiple drilling heads 106 are displaceable by means of a servo drive (not shown in detail) in a direction at right angles to the main wall 32, in the manner indicated by an arrow 110.

The positioning unit 40 comprises a groove detector 112, which may be formed e.g. by a television camera and a downstream electronic image analysis device. The groove detector 112 produces an output signal when it is situated above a previously produced groove.

When said output signal is received, positioning parts 116 are moved into grooves situated above them by pneumatic cylinders 114. An overall positioning of the machining unit 36 therefore occurs. Thus, by virtue of orientation by grooves which have just been produced, the machining unit 36 may be moved on by increments corresponding exactly to one pitch of the mounting rail 54 (i.e. to the length of a stator core 58).

FIG. 5 shows an embodiment of the positioning unit 40, in which two positioning parts 116 are provided, which cooperate in each case with one of the mounting grooves 60, 72. When the groove detector 112 is disposed in such a way that it cooperates with the right or the left end face of the mounting rail 56, a positioning part 116 and an associated pneumatic cylinder 114 may be provided also for the positioning groove 66 of a set of grooves.

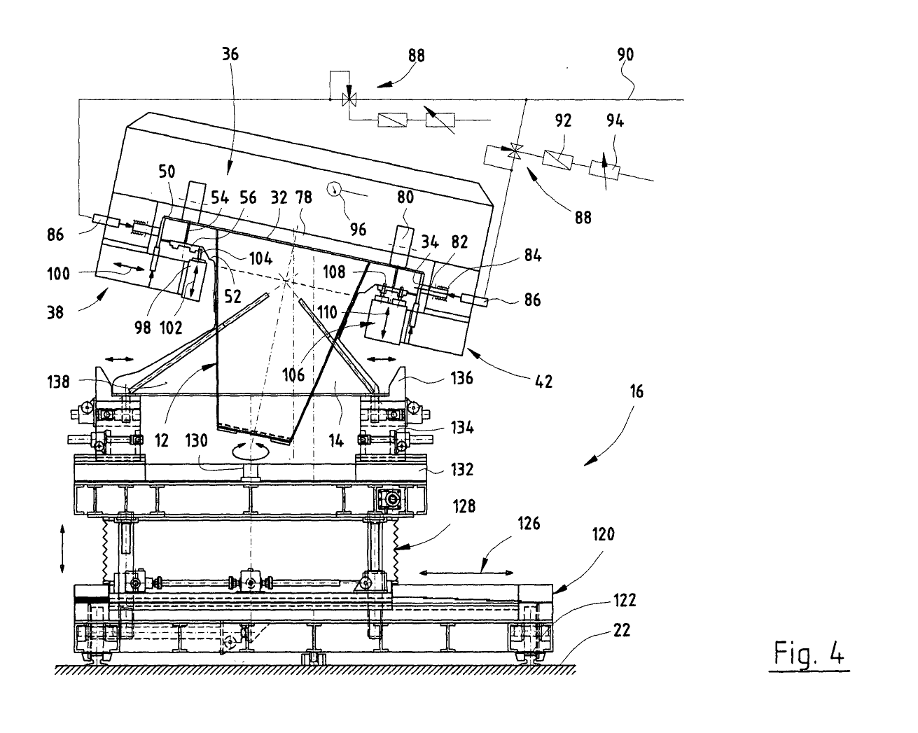

Given more than one positioning part 116, one of the positioning parts is worked in such a way that it fits absolutely without play into the associated groove. To avoid redundancy, the other positioning parts are worked with slight play, as is shown in an exaggerated manner in FIG. 3.

The positioning parts 116 each have a insertion slant 118, as is illustrated also in the detail enlargement of FIG. 5.

The insertion slants 118 of the outer positioning parts 116-1 and 116-3 of FIG. 3 are longer than that of the middle positioning part 116-2. The latter has a shorter length than the positioning parts 116-1 and 116-3. Thus, the positioning parts 116-1 and 116-3, which first come into engagement, extensively align the positioning unit 40 and hence the machining unit 36 with the grooves 70 and 72, before the positioning part 116-2 together with the groove 68 then effects the final fine-positioning.

As is evident from FIGS. 4 and 5, the base unit 16 (and analogously the base units 18 and 20) has an undercarriage 120, which is displaceable along rails 122 let into the floor of the factory hall. The undercarriage 120 via a transverse slide 126, which is not to be described in detail here, carries a vertical adjustment unit 120. The latter via a pivot bearing 122 having a vertical axis of rotation carries a bearing trough 124. The latter has a circular bearing surface and with the latter supports a receiving table 126, which at the underside has a complementary bearing surface. On the receiving table 126 foot portions of end plates 130, which are provided on the ends of the rail segment 10, are positioned by means of transversely displaceable claws 128.

It is evident that by said means the end of a rail segment is adjustable in height and inclination in any desired manner in order that a curved and possibly twisted rail segment 10 may be received.

While in the case of the base units 16 and 18 the end plates 130 are transversely positioned only between the correspondingly positioned claws 128, the claws 128 of the middle base unit are pressed firmly against a middle fastening plate, corresponding to the end plate 130, of the rail segment 10 so that the latter is absolutely fixed at said point.

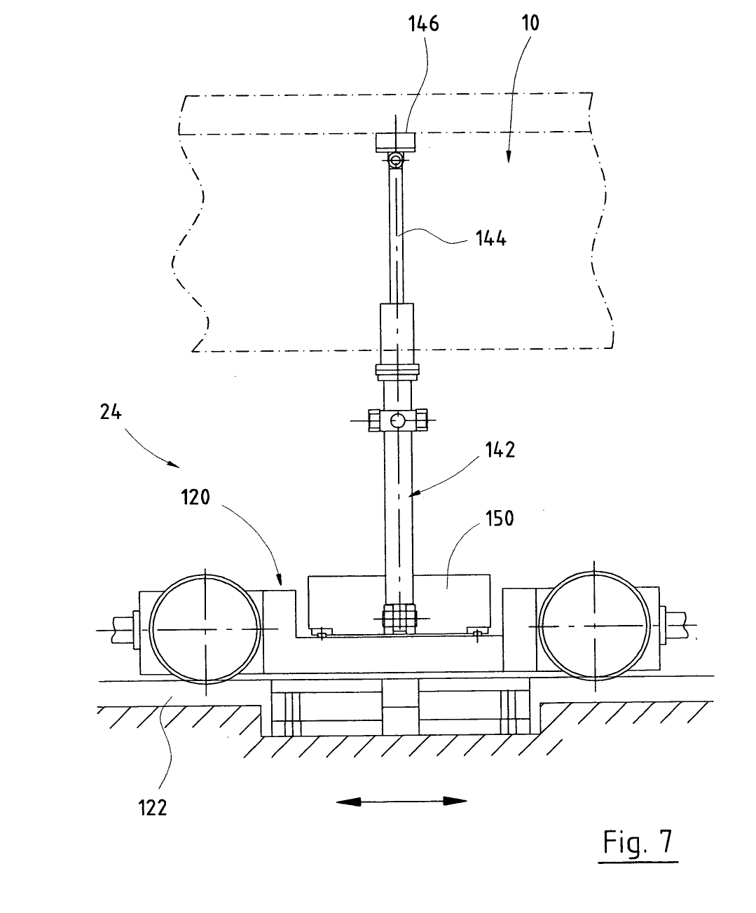

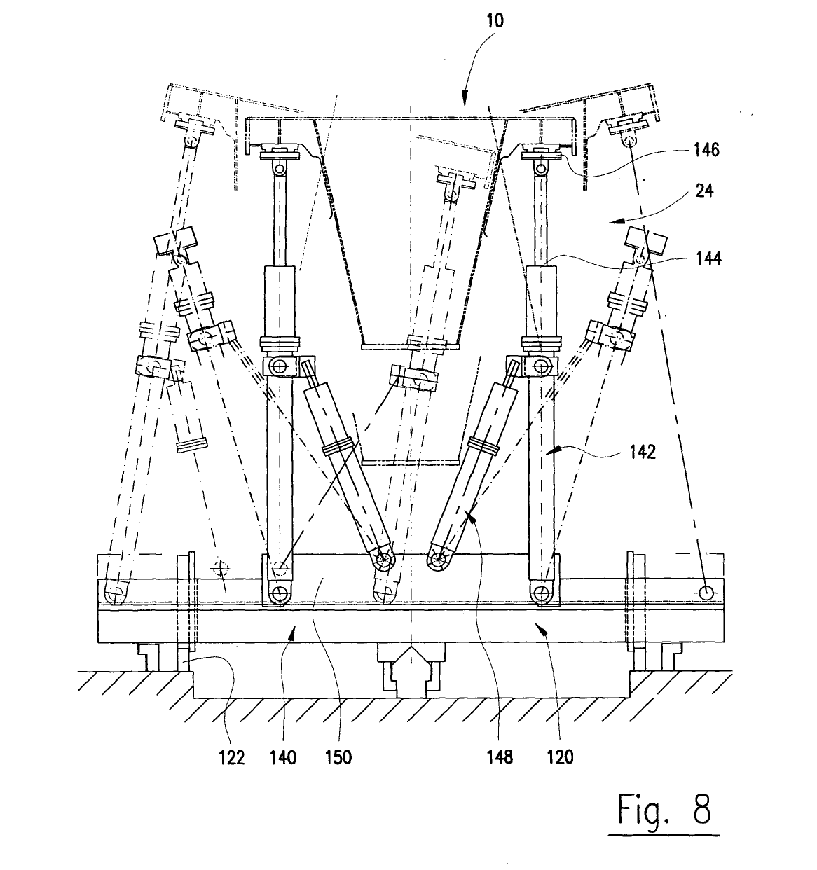

As is apparent from FIGS. 7 and 8, the base units 24 have an undercarriage 140, which likewise runs along the rails 122 and carries in a pivotal manner hydraulic cylinders 142. The piston rods 144 of the latter carry tilting support plates 146, which cooperate with the underside of a stator mounting rail 56.

The hydraulic cylinders 142 are pivotable on the undercarriage 140 about an axis parallel to the workpiece longitudinal axis and their inclination is adjustable by means of further hydraulic cylinders 148. In said manner the position of the support plates 146 may be adapted to the setpoint position and setpoint inclination of the associated mounting rail 56, as indicated by dashed lines in FIG. 8.

A lateral adjustability of the support plates 146 may additionally be achieved by travelling of a base block 150 on the undercarriage 140 in lateral direction.

The base units 30 for the parking segments 26 and 28 are of a very similar construction to the base units 24 (alternatively also 20) except that fastening means are provided there for connecting the support plates 146 firmly to the mounting rails 56.

The machining device described above operates as follows:

First, the machining unit 36 is parked on one of the parking segments 26, 28, e.g. on the parking segment 26. Then a rail segment 10 is placed onto the base units 16, 18 and 20, wherein the claws 136 of the latter are adjusted in height and inclination and in their angular position about the vertical axis, as specified for the corresponding points of the rail segment in the production data of the respective rail segment 10.

Then the various base units 24 are successively adjusted likewise in such a way that the positions specified in the production data are reached at the corresponding points of the rail segment 10. On completion of said adjustment operations, the claws 136 of the base unit 20 are pressed firmly against the fastening plate, which is situated near the middle of the rail segment and corresponds in its geometry to an end plate 138.

The two parking segments 26 and 28 are then adjusted by suitable loading of the various hydraulic cylinders 142 and 148 with pressure medium in such a way that each parking segment with its top and its side surfaces forms a uniform and smooth continuation of the adjacent end of the rail segment 10. Said adjustment of the hydraulic cylinders may be effected automatically by a control computer based on the production data for the rail segment to be machined in each case.

As the parking segments 26 and 28 totally correspond in their construction to the construction of a short inner segment, their mounting rails 56 likewise have positioning grooves 68 and mounting grooves 70, 72. These are used at the start of machining as reference marks for the groove detector 112 and the positioning parts 116.

The machining unit is first moved by one pitch (i.e. the distance between one positioning groove 68 and the next positioning groove and/or the distance between successive groups of grooves) along the rail segment 10, i.e. given the assumed initial state, to the right in FIG. 1.

The milling heads 102 are then set in operation and moved in transverse direction. As a result, a set of grooves 68, 70, 72 is produced in each of the two mounting rails 56.

The milling heads 102 are then set laterally alongside the mounting rails 56, and the machining unit 36 is moved one pitch further along the rail segment 10. The positioning unit 40 of the machining unit 36 is then situated over the grooves 68 to 72 just produced and may use them to reposition the machining unit 36 exactly, in the manner described above with reference to the parking segment 26. A second set of grooves 68 to 72 is then produced in the mounting rails 56. On completion of the latter, the machining unit 36 is moved one pitch further to the right, with the result that the positioning unit 40 again comes to lie over the grooves just newly produced. In addition, the multiple drilling heads 106 are now situated above the grooves produced during the last-but-one step.

In the next machining cycle a set of grooves 68 to 72 is again produced in the two mounting rails 56. At the same time, however, a set of through-holes 74 may also be produced by the multiple drilling heads 106.

At the end of this cycle the machining unit 36 is again moved one pitch further, and the cycle last described is repeated. All of this continues until the machining unit 36 runs off the, in FIG. 1, right end of the rail segment 10 onto the parking segment 28. During the last two work cycles, in which the milling heads 102 are already situated above the parking segment 28, the milling heads remain switched off. And during the last work cycle, in which only the last through-holes 74 are produced in the right end of the rail segment 10, the positioning unit 40 is already using the grooves in the right parking segment 28 to position the multiple drilling head 106.

If it is desired that during the last work cycle drilling of the through-bores is effected using, not reference marks carried by the parking segment 28, but newly produced grooves instead, the positioning unit 40 may in a modification alternatively be disposed downstream of the drilling unit 42, i.e. to the left thereof in FIG. 1.

Especially when a large number of milling-cutter spindles and drilling spindles are disposed successively in workpiece longitudinal direction on the machining unit 36, the machining unit 36 becomes relatively long. This may lead to problems with rail segments which are curved and/or twisted to a greater extent.

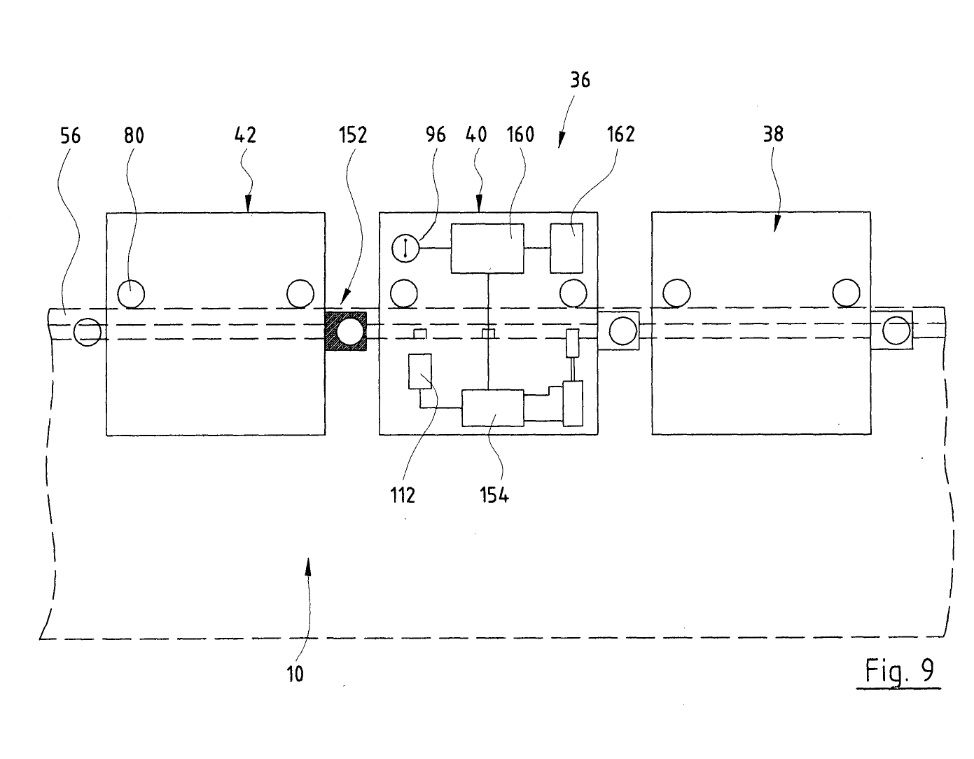

The machining unit may then be subdivided into a plurality of sub-units, e.g. three sub-units corresponding to the milling unit 38, the positioning unit 40 and the drilling unit 42. In the embodiment according to FIG. 9 such units are connected in each case by a coupling 152, which comprises a ball-and-socket joint. Thus, the individual sub-units may rotate in any desired manner in space relative to one another.

It goes without saying that each of the sub-units then comprises an individual frame and separate sets of support rollers 80 and guide rollers 82, as described above for the machining unit 36 as a whole.

The position of the couplings 152 is selected such that the hinge point is aligned with the neutral axis of the plane defined by the centres of the grooves 68, 70, 72. Thus, the swivelling motion of the individual sub-units leads to only very slight variations in the operation of the milling-cutters and drill bits.

FIG. 9 additionally shows an arithmetic and control unit 154, which analyses the image of the optical groove detector 112 and via which the loading of a pneumatic cylinder 114 with pressure medium is effected.

An arithmetic unit 156 is additionally provided in the positioning unit 140 and cooperates with a mass storage device 158, in which are filed the production data for the rail segment just machined, in particular the inclination of the main wall 32 in both directions in space (transverse and longitudinal inclination). These data are filed in the mass storage device 158 with a resolution, which is at least as good as the pitch of the mounting rails 56.

The arithmetic and control unit 154 acts upon the arithmetic unit 156 with pulses which it produces each time the groove detector 112, after the machining unit 36 has been moved one pitch further, discovers a groove used to align the machining unit 36. Thus, the arithmetic unit 156 knows exactly at which point the machining unit 36 is actually situated.

The arithmetic unit 156 is further shown connected to the inclination sensor 96. It is therefore able to calculate both from the output signal of the inclination sensor 96 and from the position of the machining unit 36 and the production data filed in the mass storage device 158 the additional pneumatic compensation force required at one of the pneumatic cylinders 86 to compensate the weight-related asymmetry of the self-centring of the machining unit 36 onto the rail segment 10. The arithmetic and control unit produces an electrical signal suitable for said purpose, according to which the magnets 92 are energized.

In a modification of the above embodiments, the arresting of the machining unit 36 at the various pitch points of the rail segment may alternatively be effected by using the recess detector 112 to control pneumatic cylinders 114′ carrying clamping parts 116′, which cooperate in a force-type locking manner with one of the surfaces of the rail segment 10, e.g. with the bottom end face of the side walls 34, in the manner also illustrated in FIG. 4.

The foregoing description merely explains and illustrates the invention and the invention is not limited thereto except insofar as the appended claims are so limited, as those skilled in the art who have the disclosure before them will be able to make modifications without departing from the scope of the invention.

1. Apparatus for producing a succession of regularly spaced recesses in an elongate workpiece comprising: a machining head, which comprises at least one tool for the cutting of material, and having a device for producing a relative movement between machining head and workpiece, the machining head is disposed on an undercarriage comprising two sets of guide means, which cooperate with differently inclined boundary surfaces of the workpiece, and that the undercarriage additionally comprises at least one positioning means, which is capable of cooperating with recesses disposed in the workpiece, in particular being displaceable between an idle position raised off the workpiece and an operating position cooperating in a force-type locking manner with the workpiece.

2. Apparatus according to claim 1, wherein the positioning means comprise a contactlessly operating detector for a recess as well as a clamping device, which is carried by the undercarriage and cooperates with the workpiece and which in dependence upon the output signal of the recess detector is transferable between a release position and a clamping position.

3. Apparatus according to claim 1, wherein the positioning means include a positioning part, which is movable without play and at least partially positively into a recess.

4. Apparatus according to claim 3, wherein the positioning part has an insertion slant.

5. Apparatus according to claim 3, further comprising a servomotor for moving the positioning part between an idle position disengaged from the workpiece and a positioning position of engagement into a recess.

6. Apparatus according to claim 5, wherein the undercarriage has a contactlessly operating recess detector, which responds optically to a recess and by means of the output signal of which the servo motor is movable into its operating position corresponding to the positioning position of the positioning part.

7. Apparatus according to claim 1 for use with a workpiece, which has a main wall with a substantially horizontal extension component and two side walls with a substantially vertical extension component, the apparatus further comprising the guide means facing the side walls are adjustable in a transverse direction parallel to the main wall and are preloaded in each case by identically constructed preloading devices in the direction of the adjacent side wall.

8. Apparatus according to claim 7, wherein the preloading devices comprise springs.

9. Apparatus according to claim 7, wherein the preloading devices comprise pneumatic cylinders, which are loaded with compressed air via at least one pressure regulator.

10. Apparatus according to claim 9, wherein the one pressure regulator is provided for each of the pneumatic cylinders associated with the two side walls.

11. Apparatus according to claim 10, wherein the pressure regulators are controllable in terms of their control pressure and a signal associated with the inclination of the main wall relative to the horizontal is supplied to their control inputs.

12. Apparatus according to claim 11, wherein the pressure-regulating control signals are derived from an inclination sensor carried by the undercarriage.

13. Apparatus according to claim 11, wherein the pressure-regulating control signals are derived from a position sensor, which is carried by the vehicle and which supplies a signal corresponding to the instantaneous distance of the machining unit from the end of the workpiece.

14. Apparatus according to claim 1, wherein the undercarriage carries an operation controller, which controls the operation of the working heads and of the positioning means in dependence upon characteristic data of the workpiece, which are filed in a mass storage device cooperating with the operation controller, or carries a modem part, via which there is a connection to a space-fixed operation controller of said type.

15. Apparatus according to claim 1, wherein the working heads include at least one milling machine, which is displaceable in transverse direction to the longitudinal axis of the workpiece.

16. Apparatus according to claim 15, wherein the milling machine or the milling cutter is additionally displaceable in axial direction.

17. Apparatus according to claim 15, wherein the milling machine is additionally displaceable in longitudinal direction of the workpiece.

18. Apparatus according to claim 1, wherein the working heads include at least one drilling machine.

19. Apparatus according to claim 15, wherein the undercarriage carries a plurality of at least one of milling machines and drilling machines disposed successively at identical intervals in longitudinal direction of the workpiece.

20. Apparatus according to claim 19, wherein the milling machines and the drilling machines are combined into groups.

21. Apparatus according to claim 20, wherein the groups of milling machines and the group of drilling machines are carried by independent undercarriages, which are connected to one another by joints.

22. Apparatus according to claim 1, wherein the positioning means are carried by a separate undercarriage, which is connected flexibly to another undercarriage.

23. Apparatus according to claim 21, wherein the hinge points of the joints lie at the height of the neutral axis of the portions of the workpiece which are to be machined.

24. Apparatus according to claim 1, wherein a plurality of independently movable undercarriages are provided, which each carry at least one working head.

25. Apparatus according to one of claims 1, further comprising parking parts, which are situated near the ends of the workpiece and have boundary surfaces, which at least in the surface regions cooperating with the guide means are a uniform smooth continuation of the boundary surfaces of the workpiece.

26. Apparatus according to claim 25, wherein the parking parts have identical cross sections and an identical construction to portions of the workpiece .

27. Apparatus according to claim 25, wherein the parking parts are carried by base units, which have fastening parts that are adjustable in height and/or inclination.

28. Apparatus according to claim 27, wherein the base units for the parking parts are of a substantially identical construction to the base units used to support the workpiece.

29. Apparatus according to claim 1, wherein the elongate workpiece comprises a rail segment for a magnetic levitation system.

30. Apparatus according to claim 1, wherein the contactlessly operating detector comprises an optically operating detector.

31. Apparatus according to claim 8, wherein the springs comprise cup spring stacks.
